(19) United States
(12) Patent Application Publication
(10) Pub. No.: US 2025/0308130 A1
(43) Pub. Date: Oct. 2, 2025

(54) PROGRAMMABLE PIXEL DISTRIBUTION

(71) Applicant: Advanced Micro Devices, Inc., Santa Clara, CA (US)

(72) Inventors: Nishank Pathak, Orlando, FL (US); Dana G. Schaa, Santa Clara, CA (US); Ping Hang Cheung, Folsom, CA (US)

(73) Assignee: Advanced Micro Devices, Inc., Santa Clara, CA (US)

(21) Appl. No.: 18/620,693

(22) Filed: Mar. 28, 2024

(51) Int. Cl. G06T 15/00

(52) U.S. Cl. CPC G06T 15/005; G06T 2210/52

(57) ABSTRACT

A technique for rendering is provided. The technique includes distributing primitives to a set of screen space processors based on a first assignment configuration; modifying assignment configuration to replace the first assignment configuration with a second assignment configuration; and distributing primitives to the set of screen space processors based on the second assignment configuration.

### BACKGROUND

Three-dimensional graphics processing involves rendering three-dimensional scenes by converting models specified in a three-dimensional coordinate system to pixel colors for an output image. Improvements to three-dimensional graphics processing are constantly being made.

### BRIEF DESCRIPTION OF THE DRAWINGS

A more detailed understanding may be had from the following description, given by way of example in conjunction with the accompanying drawings wherein:

FIG. 1 is a block diagram of an example computing device in which one or more features of the disclosure can be implemented;

FIG. 2 illustrates details of the device of FIG. 1 and an accelerated processing device, according to an example;

FIG. 3 is a block diagram showing additional details of the graphics processing pipeline illustrated in FIG. 2;

FIG. 4 illustrates a redistributor which is configured to accept output from one or more world-space processors and redistributor that work to one or more screen-space processors;

FIG. 5 illustrates an example render target; and

FIG. 6 is a flow diagram of a method for operating a graphics processing pipeline, according to an example.

### DETAILED DESCRIPTION

In a rasterization-based rendering pipeline, geometry is processed to generate output pixels of an image (a “render target,” which can be, e.g., a texture or frame buffer for display). Coarsely, this pipeline is divided into two sections: a world-space pipeline and a screen-space pipeline. Among other things, the world-space pipeline converts geometry defined in a world-space (e.g., a global, three-dimensional coordinate system) into geometry in a screen-space (e.g., a space whose coordinate system corresponds to that of a screen or output image, and also includes the notion of depth). The screen-space pipeline processes the geometry in the screen-space, determining which pixels are affected by each item of screen-space geometry, as well as determining the colors for such pixels.

The world-space and screen-space work can be parallelized by dividing the work up and executing the work in different processors in parallel. In order to take advantage of memory access locality, the output of the world-space pipeline is redistributed among the different processors for the screen-space pipeline. Such redistribution has the result that the processor that performs the world-space work for a particular item of geometry does not have to be the processor that performs the screen-space work for that same item of geometry.

In some examples, this redistribution is based on the render target tiles that are overlapped by the output of the world-space pipeline. A render target tile is a subdivision of the render target. More specifically, each processor executing screen space work is assigned a particular set of one or more render target tiles. Then, if a particular output element (e.g., triangle) of the world-space pipeline overlaps that render target tile, a redistributor sends that output element to the processor associated with that render target tile.

Techniques disclosed herein provide for a customized way to assign render target tiles to processors performing screen space work. Changing such assignments changes the screen space processors to which a redistributor transmits data (e.g., triangles from the world space pipelines). In an example, at a first time, render target tiles are assigned to screen space processors in one way and at a second time subsequent to the first time, the render target tiles are assigned to the screen space processors with at least one difference (e.g., at least one render target tile at the second time is assigned to a different screen space processor than at the first time). Any set of changes of assignments is possible. Providing the capability to programmatically adjust the redistribution of screen space work allows for various optimizations such as load balancing, adjusting for quirks in rendered content, power savings (e.g., by consolidating processing to one or more processors), or other capabilities.

A technique for rendering is provided. The technique includes distributing primitives to a set of screen space processors based on a first assignment configuration; modifying assignment configuration to replace the first assignment configuration with a second assignment configuration; and distributing primitives to the set of screen space processors based on the second assignment configuration.

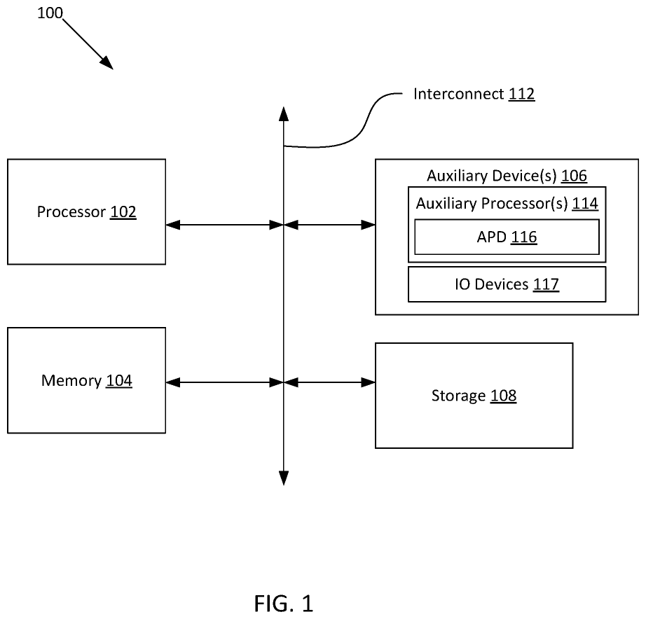

FIG. 1 is a block diagram of an example computing device 100 in which one or more features of the disclosure can be implemented. In various examples, the computing device 100 is one of, but is not limited to, for example, a computer, a gaming device, a handheld device, a set-top box, a television, a mobile phone, a tablet computer, or other computing device. The device 100 includes, without limitation, one or more processors 102, a memory 104, one or more auxiliary devices 106, and a storage 108. An interconnect 112, which can be a bus, a combination of buses, and/or any other communication component, communicatively links the one or more processors 102, the memory 104, the one or more auxiliary devices 106, and the storage 108.

In various alternatives, the one or more processors 102 include a central processing unit (CPU), a graphics processing unit (GPU), a CPU and GPU located on the same die, or one or more processor cores, wherein each processor core can be a CPU, a GPU, or a neural processor. In various alternatives, at least part of the memory 104 is located on the same die as one or more of the one or more processors 102, such as on the same chip or in an interposer arrangement, and/or at least part of the memory 104 is located separately from the one or more processors 102. The memory 104 includes a volatile or non-volatile memory, for example, random access memory (RAM), dynamic RAM, or a cache.

The storage 108 includes a fixed or removable storage, for example, without limitation, a hard disk drive, a solid state drive, an optical disk, or a flash drive. The one or more auxiliary devices 106 include, without limitation, one or more auxiliary processors 114, and/or one or more input/output (“IO”) devices. The auxiliary processors 114 include, without limitation, a processing unit capable of executing instructions, such as a central processing unit, graphics processing unit, parallel processing unit capable of performing compute shader operations in a single-instruction-multiple-data form, multimedia accelerators such as video encoding or decoding accelerators, or any other processor. Any auxiliary processor 114 is implementable as a programmable processor that executes instructions, a fixed function processor that processes data according to fixed hardware circuitry, a combination thereof, or any other type of processor.

The one or more auxiliary devices 106 includes an accelerated processing device (“APD”) 116. The APD 116 may be coupled to a display device, which, in some examples, is a physical display device or a simulated device that uses a remote display protocol to show output. The APD 116 is configured to accept compute commands and/or graphics rendering commands from processor 102, to process those compute and graphics rendering commands, and, in some implementations, to provide pixel output to a display device for display. As described in further detail below, the APD 116 includes one or more parallel processing units configured to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and, optionally, configured to provide graphical output to a display device. For example, it is contemplated that any processing system that performs processing tasks in accordance with a SIMD paradigm may be configured to perform the functionality described herein. Alternatively, it is contemplated that computing systems that do not perform processing tasks in accordance with a SIMD paradigm perform the functionality described herein.

The one or more IO devices 117 include one or more input devices, such as a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals), and/or one or more output devices such as a display device, a speaker, a printer, a haptic feedback device, one or more lights, an antenna, or a network connection (e.g., a wireless local area network card for transmission and/or reception of wireless IEEE 802 signals).

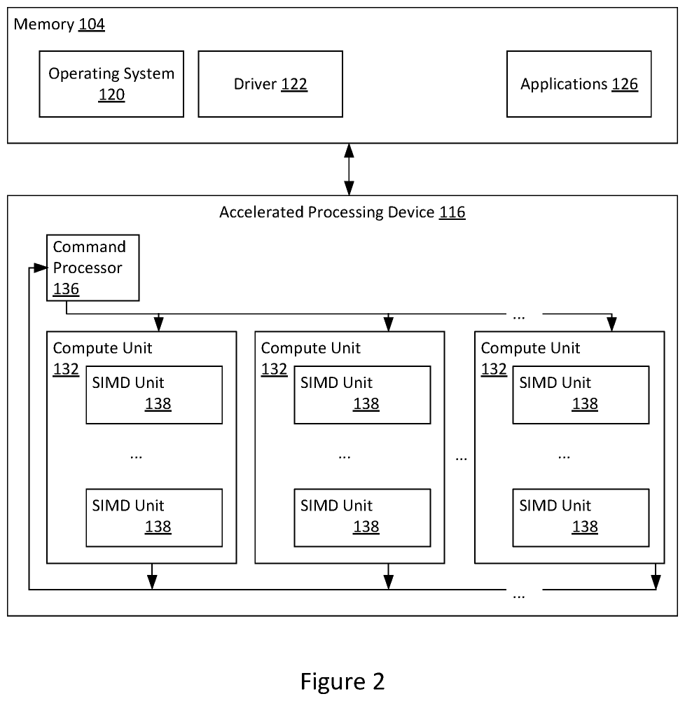

FIG. 2 illustrates details of the device 100 and the APD 116, according to an example. The processor 102 (FIG. 1) executes an operating system 120, a driver 122 (“APD driver 122”), and applications 126, and may also execute other software alternatively or additionally. The operating system 120 controls various aspects of the device 100, such as managing hardware resources, processing service requests, scheduling and controlling process execution, and performing other operations. The APD driver 122 controls operation of the APD 116, sending tasks such as graphics rendering tasks or other work to the APD 116 for processing. The APD driver 122 also includes a just-in-time compiler that compiles programs for execution by processing components (such as the SIMD units 138 discussed in further detail below) of the APD 116.

The APD 116 executes commands and programs for selected functions, such as graphics operations and non-graphics operations that may be suited for parallel processing. The APD 116 can be used for executing graphics pipeline operations such as pixel operations, geometric computations, and rendering an image to a display device based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 that include one or more SIMD units 138 that are configured to perform operations at the request of the processor 102 (or another unit) in a parallel manner according to a SIMD paradigm. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program that is to be executed in parallel in a particular lane. Work-items can be executed simultaneously (or partially simultaneously and partially sequentially) as a “wavefront” on a single SIMD processing unit 138. One or more wavefronts are included in a “work group,” which includes a collection of work-items designated to execute the same program. A work group can be executed by executing each of the wavefronts that make up the work group. In alternatives, the wavefronts are executed on a single SIMD unit 138 or on different SIMD units 138. Wavefronts can be thought of as the largest collection of work-items that can be executed simultaneously (or pseudo-simultaneously) on a single SIMD unit 138. “Pseudo-simultaneous” execution occurs in the case of a wavefront that is larger than the number of lanes in a SIMD unit 138. In such a situation, wavefronts are executed over multiple cycles, with different collections of the work-items being executed in different cycles. A command processor 136 is configured to perform operations related to scheduling various workgroups and wavefronts on compute units 132 and SIMD units 138.

The parallelism afforded by the compute units 132 is suitable for graphics related operations such as pixel value calculations, vertex transformations, and other graphics operations. Thus in some instances, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the APD 116 for execution.

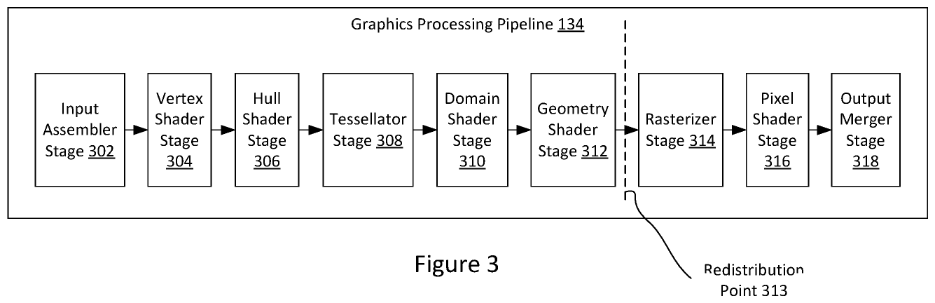

FIG. 3 is a block diagram showing additional details of the graphics processing pipeline 134 illustrated in FIG. 2. The graphics processing pipeline 134 includes stages that each performs specific functionality of the graphics processing pipeline 134. Each stage is implemented partially or fully as shader programs executing in the programmable compute units 132, or partially or fully as fixed-function, non-programmable hardware external to the compute units 132.

The input assembler stage 302 reads primitive data from user-filled buffers (e.g., buffers filled at the request of software executed by the processor 102, such as an application 126) and assembles the data into primitives for use by the remainder of the pipeline. The input assembler stage 302 can generate different types of primitives based on the primitive data included in the user-filled buffers. The input assembler stage 302 formats the assembled primitives for use by the rest of the pipeline.

The vertex shader stage 304 processes vertices of the primitives assembled by the input assembler stage 302. The vertex shader stage 304 performs various per-vertex operations such as transformations, skinning, morphing, and per-vertex lighting. Transformation operations include various operations to transform the coordinates of the vertices. These operations include one or more of modeling transformations, viewing transformations, projection transformations, perspective division, and viewport transformations, which modify vertex coordinates, and other operations that modify non-coordinate attributes.

The vertex shader stage 304 is implemented partially or fully as vertex shader programs to be executed on one or more compute units 132. The vertex shader programs are provided by the processor 102 and are based on programs that are pre-written by a computer programmer. The driver 122 compiles such computer programs to generate the vertex shader programs having a format suitable for execution within the compute units 132.

The hull shader stage 306, tessellator stage 308, and domain shader stage 310 work together to implement tessellation, which converts simple primitives into more complex primitives by subdividing the primitives. The hull shader stage 306 generates a patch for the tessellation based on an input primitive. The tessellator stage 308 generates a set of samples for the patch. The domain shader stage 310 calculates vertex positions for the vertices corresponding to the samples for the patch. The hull shader stage 306 and domain shader stage 310 can be implemented as shader programs to be executed on the compute units 132, that are compiled by the driver 122 as with the vertex shader stage 304.

The geometry shader stage 312 performs vertex operations on a primitive-by-primitive basis. A variety of different types of operations can be performed by the geometry shader stage 312, including operations such as point sprite expansion, dynamic particle system operations, fur-fin generation, shadow volume generation, single pass render-to-cubemap, per-primitive material swapping, and per-primitive material setup. In some instances, a geometry shader program that is compiled by the driver 122 and that executes on the compute units 132 performs operations for the geometry shader stage 312.

The rasterizer stage 314 accepts and rasterizes simple primitives (triangles) generated upstream from the rasterizer stage 314. Rasterization consists of determining which screen pixels (or sub-pixel samples) are covered by a particular primitive. Rasterization is performed by fixed function hardware.

The pixel shader stage 316 calculates output values for screen pixels based on the primitives generated upstream and the results of rasterization. The pixel shader stage 316 may apply textures from texture memory. Operations for the pixel shader stage 316 are performed by a pixel shader program that is compiled by the driver 122 and that executes on the compute units 132.

The output merger stage 318 accepts output from the pixel shader stage 316 and merges those outputs into a frame buffer, performing operations such as z-testing and alpha blending to determine the final color for the screen pixels.

As described elsewhere herein, many of the stages of the pipeline are implemented at least partially with shader programs executing on the APD (e.g., within the SIMD units 138). Some of these stages are part of the world-space pipeline and other stages are part of the screen-space pipeline. The redistribution point 313 defines the boundary between the world-space pipeline, which includes all stages prior to the redistribution point 313, and the screen-space pipeline, which includes all stages after the redistribution point 313.

Work (e.g., vertices obtained by the input assembler stage 302) is processed in a set of processors (e.g., a set of SIMD units 138) in the world-space pipeline. In order to take advantage of memory access locality, the output of work that is processed in the world-space pipeline (e.g., triangles having coordinates transformed to the screen space) is redistributed among different processors (e.g., a different set of SIMD units 138) for the screen-space pipeline. In some examples, this redistribution is based on the render target tiles that are overlapped by the output of the world-space pipeline. A render target tile is a subdivision of the render target. More specifically, each processor is assigned a particular set of one or more render target tiles. Then, if a particular output element (e.g., triangle) of the world-space pipeline overlaps that render target tile, a redistributor sends that output element to the processor associated with that render target tile.

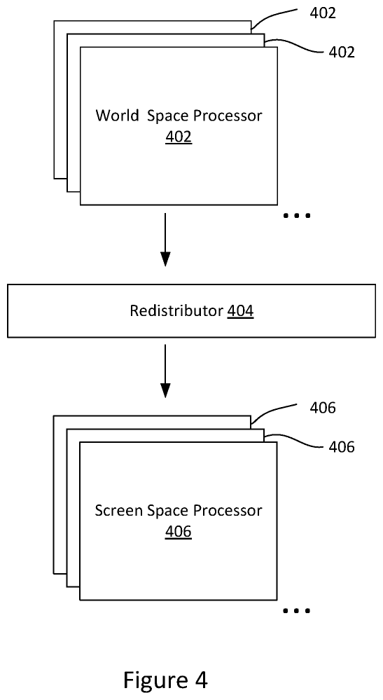

FIG. 4 illustrates a redistributor 404 which is configured to accept output from one or more world-space processors 402 and redistribute that work to one or more screen-space processors 406. The one or more world-space processors 402 include the hardware associated with the stages of the world-space pipeline. In an example, one or more of the world space processors 402 include a set of one or more SIMD units 138 (which are programmable processors configured to execute shader programs) as well as one or more sets of fixed function circuitry or programmable circuitry that is configured to perform the functionality of the various shader stages of the world-space pipeline as defined herein. In an example, one or more of the screen-space processors 406 includes a set of one or more SIMD units 138 as well as one or more sets of fixed function circuitry or programmable circuitry that is considered to perform the functionality of the various shader stages of the screen space pipeline as defined herein. In some examples, SIMD units 138 are used for both the world-space pipeline and the screen-space pipeline. In other words, in some examples, the world-space processors 402 and the screen-space processors 406 include at least some of the same SIMD unit 138. In various examples, the redistributor 404 is hard-wired circuitry, a processor, or other circuitry configured to perform the operations described herein (e.g., the operations described as being performed by the redistributor 404). In various examples, the redistributor 404 is within the APD 116. In some examples, there are multiple redistributors 404 within the APD 116 (e.g., one per compute unit 132).

The redistributor 404 receives output from the world-space processors 402, such as triangles with positions specified in screen space and transmits the triangles to the screen space processor 406 that is assigned to a tile overlapped by the triangle. For any given triangle (e.g., for all triangles), the redistributor 404 transmits that triangle to each screen space processor 406 that is associated with a render target tile that is overlapped by the triangle. It is possible for any given triangle to overlap render target tiles for multiple screen space processors 406, in which case the redistributor 404 transmits such a triangle to each such screen space processor 406. In some examples, the redistributor 404 does not transmit any triangle to any screen space processor 406 that is associated with a render target tile that the triangle does not overlap.

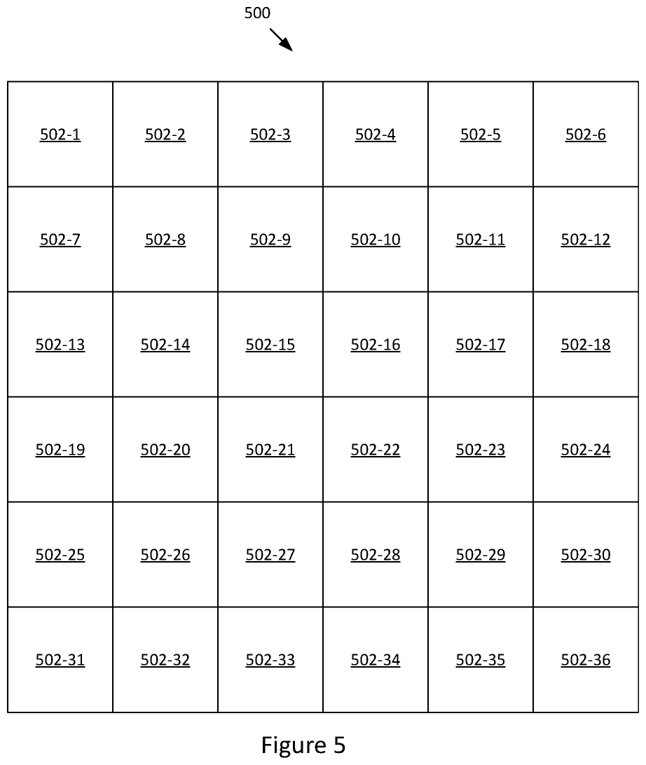

FIG. 5 illustrates an example render target 500. A render target is a memory buffer into which the results of the graphics processing pipeline 134 are written. In an example, the render target is a frame buffer from which a rendered image is displayed to a display device or output in some other manner. In other examples, the render target is a different type of buffer such as a buffer that is used in multi-pass rendering. In such an example, an image is rendered into such a render target and then that image is used subsequently to render one or more additional images.

In the render target 500 of FIG. 5, 36 different render target tiles 502 are shown. As can be seen, these render target tiles 502 represent different subdivisions of the render target 500 itself. As stated above, different screen space processors 406, assigned to different render target tiles 502, are assigned different triangles by the redistributor 404.

Techniques disclosed herein provide for a customized way to assign render target tiles 502 to screen space processors 406. Changing such assignments changes the screen space processors 406 to which the redistributor 404 transmits data (e.g., triangles from the world space pipelines 402). In an example, at a first time, the render target tiles 502 are assigned to screen space processors 406 in one way and at a second time subsequent to the first time, the render target tiles 502 are assigned to the screen space processors 406 with at least one difference (e.g., at least one render target tile 502 at the second time is assigned to a different screen space processor 406 than at the first time). Any set of changes of assignments is possible. Herein, the term “the configuration,” “the assignment configuration,” or a similar term is sometimes used. This term means the assignment of render target tiles 502 to screen space processors 406.

In various examples, any technically feasible unit is capable of making a request to the redistributor 404 to change the configuration. In response to the request to change the configuration, the redistributor 404 changes the assignment between render target tiles 502 and screen space processors 406. In some examples, the driver 122 transmits such requests to the redistributor 404. In some examples, the driver 122 performs such transmission in the course of processing commands from software executing on the processor 102 (such as an application), where that software is generating such commands for the purpose of causing the APD 116 to render graphics.

In some examples, the driver 122 or application sending commands to the driver is capable of specifying that a change in assignment configuration should occur on a “configuration boundary.” A configuration boundary is a point in processing within the device 100 at which configurations can change. In some examples, the configurations are not permitted to change at any time other than at a configuration boundary. In some examples, the configuration boundary is when a draw call occurs. In some examples, the configuration boundary is when a command buffer has been fully executed.

Above, it is stated that an application provides commands to the APD 116 for execution. In some examples, such commands are function calls in a graphics application programming interface (“API”). In some examples, the function calls include draw calls which specify geometry (e.g., triangles, specified explicitly or implicitly as a set of vertices) for the APD 116 to render. Each draw call specifies a specific set of geometry to render (or “draw”). As stated above, in some examples, the configuration boundary is a draw call. Thus, in some such examples, it is possible to change the configuration for the primitives for a new draw call. In other words, it is possible for the primitives for each different draw call to have a different configuration, but it is not possible to have a different configuration for different primitives in the same draw call.

A command buffer is a buffer of commands (e.g., commands generated as the result of API calls made by an application executing on the processor 102 and/or as the result of requests to generate such commands made by software executing on the APD 116). In operation, an entity such as the application or other software fills such command buffers and submits the command buffers for execution by the APD 116. In some examples where the configuration boundary is when a command buffer has been fully executed, the redistributor 404 is permitted to change the configuration such that primitives rendered as the result of commands from different command buffers can have a different configuration, but primitives rendered as the result of commands from the same command buffer cannot have a different configuration. In some examples, the APD 116 is capable of using multiple different configuration boundaries at the same time, such that, for example, different draw calls and different command buffers can have different configurations. In some examples, configuration boundaries other than those described herein are used, either separately or together with those described herein.

In some examples or implementations, in addition to setting which render target tiles 502 are assigned to which screen space processors 406, the assignment configuration also indicates the size of the render target tiles 502. A larger size results in a smaller number of render target tiles 502 for a given render target and, conversely, a smaller size results in a larger number of render target tiles 502. As the configuration includes render target tile 502 size, changing the configuration sometimes also includes changing the render target tile 502 size. Thus, a change in configuration can include changing render target tile 502 size, a change in the assignments of render target tiles 502 to screen space processors 406, and a change in both.

In some examples, the driver 122 defines a configuration using a table defined in a memory (e.g., a memory of the APD 116 such as a memory within a compute unit 132 or SIMD unit 138). In some examples, the table is a two-dimensional array where the x dimension of the array corresponds to a tile x coordinate and the y dimension of the array corresponds to a tile y coordinate. In such examples, the entry at table coordinate (x, y) is an identifier for the screen space processor 406 associated with the tile at tile coordinate (x, y). In other words, the two dimensional table indicates, in each entry, a particular screen space processor 406. The entry, which is defined by a coordinate (x, y), associates the identified screen space processor 406 with the render target tile 502 at coordinate (x, y). In determining which screen space processor 406 to transmit world space processor 402 output to, the redistributor 404 examines the table and transmits such output to the appropriate screen space processor 406.

In some examples, the driver 122 or another entity sets a configuration that assigns render target tiles 502 to screen space processors 406 in order to account for manufacturing defects in the screen space processors 406. More specifically, in some examples, screen space processors 406 are designed for a certain amount of throughput. In some examples, each screen space processor 406 is designed for an equal amount of throughput. However, it is possible that during manufacture, one or more of the screen space processors 406 has a defect. In such a situation, it would be beneficial to balance the amount of work among the screen space processors 406 based on the throughput available for each screen space processor 406, given the one or more defects 406. Thus, in some examples, the driver 122 or other entity causes the redistributor 404 to assign a number of render target tiles 502 to screen space processors 406 based on the comparative throughput of the screen space processors 406. In some examples, the driver 122, application, or other entity changes the assignment configuration based on runtime performance considerations in addition to or instead of making the modifications based on the throughput designated based on manufacturing defects.

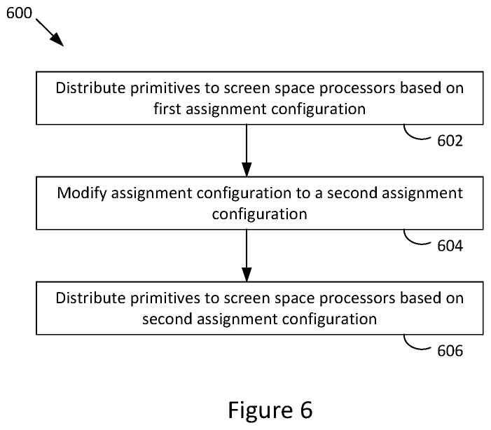

FIG. 6 is a flow diagram of a method 600 for operating a graphics processing pipeline 134, according to an example. Although described with respect to the system of FIGS. 1-5, those of skill in the art will understand that any system configured to perform the steps of the method 600 in any technically feasible order falls within the scope of the present disclosure.

At step 602, a redistributor 404 distributes primitives (output of the world-space processors 402) to screen space processors 406 based on a first assignment configuration. The first assignment configuration is a configuration that assigns render target tiles 502 to screen space processors 406. In some examples, an entity such as the driver 122 or an application executing on the processor 102 sets the configuration by transmitting one or more commands to the APD 116 that specify how the render target tiles 502 are assigned to screen space processors 406.

At step 604, the redistributor 404 modifies the assignment configuration to a second assignment configuration. Any entity, such as the driver 122 or an application executing on the processor 102 instructs the redistributor 404 as to the second assignment configuration. The change in assignment configuration can occur at a configuration boundary as described elsewhere herein, but not at a point in processing which is not a configuration boundary.

At step 606, the redistributor 404 distributes primitives to screen space processors 406 based on the second assignment configuration. This distribution involves sending the primitives to the screen space processors 406, where each primitive is sent to the screen space processor 406 that the primitive overlaps.

It should be understood that many variations are possible based on the disclosure herein. Although features and elements are described above in particular combinations, each feature or element can be used alone without the other features and elements or in various combinations with or without other features and elements.

Each of the units illustrated in the figures represent hardware circuitry configured to perform the operations described herein, software configured to perform the operations described herein, or a combination of software and hardware configured to perform the steps described herein. For example, the processor 102, memory 104, any of the auxiliary devices 106, the storage 108, APD 116, IO devices 17, the command processor 136, compute units 132, SIMD units 138, input assembler stage 302, vertex shader stage 304, hull shader stage 306, tessellator stage 308, domain shader stage 310, geometry shader stage 312, rasterizer stage 314, pixel shader stage 316, output merger stage 318, world-space processors 402, redistributor 404, or screen-space processors 406, are implemented fully in hardware, fully in software executing on processing units, or as a combination thereof. In various examples, any of the hardware described herein includes any technically feasible form of electronic circuitry hardware, such as hard-wired circuitry, programmable digital or analog processors, configurable logic gates (such as would be present in a field programmable gate array), application-specific integrated circuits, or any other technically feasible type of hardware.

The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements aspects of the embodiments.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for operating a graphics processing pipeline, the method comprising:
distributing primitives to a set of screen space processors based on a first assignment configuration;
modifying an assignment configuration to replace the first assignment configuration with a second assignment configuration; and
distributing the primitives to the set of screen space processors based on the second assignment configuration.

2. The method of claim 1, wherein the first assignment configuration comprises a set of correlations between render target tiles and the screen space processors.

3. The method of claim 2, wherein modifying the assignment configuration comprises changing a correlation of the set of correlations.

4. The method of claim 1, wherein modifying the assignment configuration comprises changing a render target tile size.

5. The method of claim 1 wherein modifying the assignment configuration is performed at a configuration boundary.

6. The method of claim 5, wherein the configuration boundary comprises a draw call or a command buffer execution.

7. The method of claim 1, wherein modifying the assignment configuration is performed at a request of a driver or an application.

8. The method of claim 1, further comprising rendering geometry based on the first assignment configuration and rendering geometry based on the second assignment configuration.

9. The method of claim 1, wherein distributing the primitives to the set of screen space processors based on the first assignment configuration includes distributing a primitive to each screen space processor that is associated with a render target overlapped by the primitive.

10. A system comprising:
a set of screen space processors; and
a redistributor processor configured to:
distribute primitives to the set of screen space processors based on a first assignment configuration;
modify an assignment configuration to replace the first assignment configuration with a second assignment configuration; and
distributing the primitives to the set of screen space processors based on the second assignment configuration.

11. The system of claim 10, wherein the first assignment configuration comprises a set of correlations between render target tiles and the screen space processors.

12. The system of claim 11, wherein modifying the assignment configuration comprises changing a correlation of the set of correlations.

13. The system of claim 10, wherein modifying the assignment configuration comprises changing a render target tile size.

14. The system of claim 10 wherein modifying the assignment configuration is performed at a configuration boundary.

15. The system of claim 14, wherein the configuration boundary comprises a draw call or a command buffer execution.

16. The system of claim 10, wherein modifying the assignment configuration is performed at a request of a driver or an application.

17. The system of claim 10, wherein the redistributor processor is further configured to render geometry based on the first assignment configuration and render geometry based on the second assignment configuration.

18. The system of claim 10, wherein distributing the primitives to the set of screen space processors based on the first assignment configuration includes distributing a primitive to each screen space processor that is associated with a render target overlapped by the primitive.

19. A non-transitory computer-readable medium storing instructions that, when executed by a processor, cause the processor to perform operations comprising:
distributing primitives to a set of screen space processors based on a first assignment configuration;
modifying an assignment configuration to replace the first assignment configuration with a second assignment configuration; and
distributing the primitives to the set of screen space processors based on the second assignment configuration.

20. The non-transitory computer-readable medium of claim 19, wherein the first assignment configuration comprises a set of correlations between render target tiles and the screen space processors.
